(19) United States
(12) Patent Application Publication
(10) Pub. No.: US 2020/0028889 A1
(43) Pub. Date: Jan. 23, 2020

(54) METHOD FOR RESOLVING PROBLEM OF SLOW SHUTDOWN SPEED OF DATA COLLECTION SOFTWARE

(71) Applicant: Fujian Foxit Software Development Joint Stock Co., Ltd., Fuzhou, Fujian (CN)

(72) Inventor: Peng Huang, Fuzhou, Fujian (CN)

(21) Appl. No.: 16/490,427

(22) PCT Filed: Apr. 1, 2017
(86) PCT No.: PCT/CN2017/000274

§ 371 Date: Aug. 30, 2019

(51) Int. Cl. H04L 29/08

(52) U.S. Cl. CPC H04L 67/06; H04L 67/12; H04L 67/02; H04L 67/1095; H04L 29/08117

(57) ABSTRACT

A method for resolving the problem of slow shutdown speed of data collection software comprises the following steps: establish a background service process, and establish a communication interface between the background service process and data collection software having an interface, the background service process being used for uploading data received from the data collection software, to a server (S110); the data collection software transmits the collected data to the background service process through the communication interface (S120); and when a user clicks a close button on the interface of the data collection software, the data collection software immediately stops running, and the background service process uploads the received data collected by the data collection software to the server (S130).

### TECHNICAL FIELD

The present invention relates to a technical field of a computer application, in particular, to a method for solving a slow shutdown speed of a data acquisition software.

### BACKGROUND OF THE INVENTION

After the data acquisition software acquires data, it is generally uploaded to the server after the software is closed. When a volume of data is relatively large, or a network speed is relatively slow, the acquisition software needs to wait for a period of time to exit. When the acquisition software having an interface, this can seriously affect a user's experience. As an amount of data acquired increases, the shutdown speed will become slower and slower. A general technical solution is to add one or more threads to upload data in them. The thread method can improve the upload speed to a certain extent, but since the main program still needs to wait for the threads to complete before it can exit. In fact, the effect is not very good when the amount of data is large.

### SUMMARY OF THE INVENTION

The invention provides a method for solving the slow closing speed of the data acquisition software, thereby solving the problem that a closing speed of a data acquisition software having an interface is slow.

In order to achieve the above object, the present invention provides a method for solving the slow shutdown speed of data acquisition software. This method comprises following steps:

establishing a background service process, and establishing a communication connection interface between said background service process and a data acquisition software with a first interface, wherein the background service process is used for uploading data received from the data acquisition software to a server;

First, to establish a background service process, and establish a communication interface between the background service process and the data acquisition software with interface, the purpose of said background service process is to upload data received from the data acquisition software to the server;

Said data acquisition software transmitting data acquired by the data acquisition software to said background service process via said communication connection interface, and said background service process receiving the data acquired by the data acquisition software;

When a user clicks a close button in the first interface of the data acquisition software, the data acquisition software immediately stopping running, and said background service process uploading the received data acquired by the data acquisition software to the server.

Further, automatically running said background service process in a background of an operating system when the user starts the operating system.

Further, automatically starting the communication connection interface of said background service process when the user opens said data acquisition software.

This invention introduces a background service process for uploading data, and establishes a communication connection interface between the data acquisition software and the background service process, so that the original data acquisition software is only responsible for acquiring data, the acquired data is transmitted via the communication connection interface to the background service process, the background service process uploads the received acquired data to the server. In comparison with the prior art, the technical solution of the present invention has one more flow of local process communication, but since generally the time needed for a communication between local processes is negligible relative to the time needed for network communication, the overall adjustment is that the data acquiring software only needs to do the two things: first, acquiring data, and second, transmitting the acquired data to the background service process. The user can obviously feel that after clicking the close button, the software is immediately closed. In addition, the background service process generally has no interface, it runs in the background of the operating system. When the data is being uploaded, the system CPU take-up rate may be somehow high, however, at other times when data is not uploaded, the background service will not occupy CPU, user will not perceive the take-up of CPU. Thus with the method proposed by this invention, the slow shutdown problem in general data acquisition software with an interface is improved. This will improve the user's experience.

### BRIEF DESCRIPTION OF THE DRAWINGS

In order to more clearly illustrate the embodiments of the present invention or the technical solutions in the prior art, the attached drawings used in the embodiments or the description to the prior art will be briefly described below. Obviously, the drawing in the following description are only from certain embodiments of the present invention, and other drawings can be obtained on the basis of these attached drawing for those ordinary technicians skilled in the art without any creative work.

FIG. 1 is a flowchart of a method for solving a slow shutdown speed of data acquisition software according to an embodiment of the present invention.

### DETAILED DESCRIPTION OF THE PREFERRED EMBODIMENTS

The technical solutions in the embodiments of the present invention are clearly and completely described below with reference to the accompanying drawings. It is obvious that the described embodiment is only a part of the embodiments of the present invention, but not all embodiments. Without departing from the inventive scope, all other embodiments obtained by technicians of ordinary skill in the art based on the embodiment of the present invention belong to the scope of protection of the present invention.

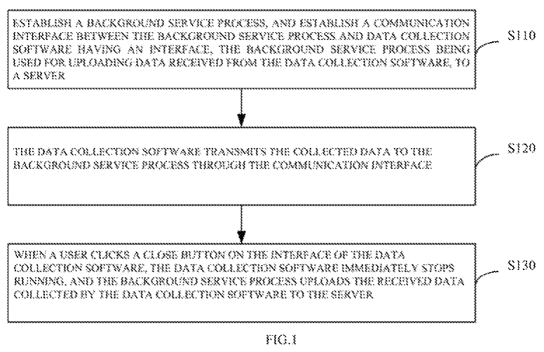

FIG. 1 is a flowchart of a method for solving a slow shutdown speed of an data acquisition software according to an embodiment of the present invention; as shown in the figure, a method for solving a slow shutdown speed of an data acquisition software includes the following steps:

S110: establishing a background service process, and establishing a communication connection interface between the background service process and the data acquisition software with the interface, said background service process is used for uploading data received from said data acquisition software to the server;

S120: The data acquisition software transmitting the acquired data to the background service process via said communication connection interface, and said background service process receiving the data acquired by the data acquisition software.

S130: When the user clicks a close button in the first interface of the data acquisition software, the data acquisition software immediately stops running, and the background service process uploading the received data acquired by the data acquisition software to the server.

This invention introduces a background service process for uploading data, and establishes a communication connection interface between the data acquisition software and the background service process, so that the original data acquisition software is only responsible for acquiring data, and transmitting the acquired data via the communication connection interface to the background service process, the background service process uploads the received acquired data to the server. In comparison with the prior art, the technical solution of the present invention has one more flow of local process communication, but since generally the time needed for communications between local processes is negligible relative to that of network communication, the overall adjustment is that the data acquiring software only needs to do the two things of: first, acquiring data, and second, transmitting the acquired data to the background service process. The user can obviously feel that after clicking the close button, the software is immediately closed. In addition, the background service process generally has no interface, it runs in the background of the operating system. When the data is being uploaded, the system CPU take-up rate may be somehow high, however, at other times when data is not uploaded, the background service will not occupy CPU, user will not perceive the take-up of CPU. Thus with the method proposed by this invention, the slow shutdown problem in general data acquisition software with an interface is improved. This will improve the user's experience.

Further, when the user starts the operating system, the background service process automatically runs in the background of the operating system.

Further, when the user opens the data acquisition software, the communication connection interface with the background service process is automatically started.

Following is a description to the flow of a specific embodiment of the present invention:

[1] establishing a background service process;

[2] Transferring the codes of uploading of acquired data in the acquisition software from the original interface to the background service process, and the original data acquisition software with the interface only acquires data and does not do the uploading work;

[3] Establishing an inter-process communication mechanism between the data acquisition software with a first interface and the background service process;

[4] The data acquisition software continuously acquires relevant data and transmits the data to the background service process. During a certain time interval, the background service process uploads the received data to the server.

[5] When the user clicks the close button in the first interface of the data acquisition software, the data acquisition software immediately stops running, and the background service process continues to upload the data that has not been uploaded to the server to the server.

It will be understood by those of ordinary skill in the art that the drawings are only a schematic diagram of an embodiment, and the modules or processes in the drawings are not necessarily required to implement the invention.

It will be understood by those ordinary technicians skilled in the art that the modules in the devices in the embodiments may be distributed in the devices of the embodiments according to the description to the embodiments, or may be correspondingly changed in one or more devices different from the embodiment. The modules of the above embodiments may be combined into one module, or may be further split into multiple sub-modules.

Finally, it should be noted that the above embodiment is only used to illustrate the technical solutions of the present invention, and is not limited thereto; although the present invention has been described in detail with reference to the foregoing embodiment, those ordinary technicians skilled in the art should understand that the technical solutions described in the foregoing embodiment can be modified, or some part of the technical features can be replaced by the equivalents of technical features; these modifications and substitutions will not cause the nature of the corresponding technical solution to depart from the spirit and scope of the technical solutions of the embodiment of the present invention.

1. A method for solving slow shutdown of a data acquisition software, comprising steps of:
establishing a background service process, and establishing a communication connection interface between said background service process and a data acquisition software with a first interface, wherein the background service process is used for uploading data received from the data acquisition software to a server;
Said data acquisition software transmitting data acquired by the data acquisition software to said background service process via said communication connection interface, and said background service process receiving the data acquired by the data acquisition software;
When a user clicks a close button in the first interface of the data acquisition software, the data acquisition software immediately stopping running, and said background service process uploading the received data acquired by the data acquisition software to the server.

2. The method for solving the slow shutdown speed of the acquired data software according to claim 1, automatically running said background service process in a background of an operating system when the user starts the operating system.

3. The method for solving the slow shutdown speed of the data acquisition software according to claim 1, automatically starting the communication connection interface of said background service process when the user opens said data acquisition software.
